(19) United States
(12) Patent Application Publication
(10) Pub. No.: US 2012/0166570 A1
(43) Pub. Date: Jun. 28, 2012

(54) OPERATION AND CONTROL METHODS FOR HOST APPARATUS

(75) Inventors: Johnny CHEN, Santa Ana, CA (US); Musa Ibrahim Kakish, Santa Ana, CA (US); Ping-Shun Zeung, Santa Ana, CA (US)

(73) Assignee: I/O INTERCONNECT, LTD., Santa Ana, CA (US)

(21) Appl. No.: 13/287,206

(22) Filed: Nov. 2, 2011

Related U.S. Application Data
(60) Provisional application No. 61/426,000, filed on Dec. 22, 2010.

(51) Int. Cl. G06F 15/16

(52) U.S. Cl. 709/208

(57) ABSTRACT

An operation method for a first host apparatus is provided by the present invention. First, the operation method captures an event of the first host apparatus, so as to generate an event information. Then, the event information is transmitted to a second host apparatus, so as to control the second host apparatus.

### CROSS-REFERENCE TO RELATED APPLICATIONS

The application claims priority of U.S. provisional patent application Ser. No. 61/426,000 filed on Dec. 22, 2010, the contents of which are hereby incorporated by reference.

### FIELD OF THE INVENTION

The present invention relates to a control method, and more particularly to a control method for controlling a host apparatus.

### BACKGROUND OF THE INVENTION

Usually, the current hand-held computing device, such as the tablet computer or smart phone, is controlled by using finger or other object to touch the screen of the hand-held computing device. Therefore, a user can control the hand-held computing device very intuitively and conveniently.

However, in some situation, such like typing the short message or e-mail, the user is still used to use tradition input means, for example the using keyboard or the mouse. Therefore, some hand-held computing devices have a query keyboard, so as to make the user using habitual tool to operate the hand-held computing device. Nevertheless, since the query keyboard is too small to press the key, it is still difficult for many users.

### SUMMARY OF THE INVENTION

Therefore, the object of the present invention is to provide operation method and a control method for controlling a host apparatus by using habitual means.

An operation method for a first host apparatus is provided by the present invention. First, the operation method captures an event of the first host apparatus, so as to generate an event information. Then, the event information is transmitted to a second host apparatus, so as to control the second host apparatus.

In one embodiment of the present invention, the step of capturing the event of the first host apparatus is to detect whether or not at least one of a plurality of keys of a keyboard connected to the first host apparatus is pressed. When at least one of keys of the keyboard is pressed, it is determining that the event is triggered.

In addition, the step of capturing the event of the first apparatus is to detect whether or not a mouse connected to the first host apparatus is moved or at least one of keys or the roll wheel of the mouse is operated. When the mouse is moved or one of keys or the roll wheel is operated, it is determining that the event is triggered.

From another viewpoint, a control method for a first host apparatus is provided by the present invention. First, an event information is received from a second host apparatus. Wherein, the event information is generated by capturing an event of the second host apparatus. Therefore, the first host apparatus can be controlled according to the event information.

In one embodiment of the present invention, the event information is packed into a TCP/IP data. Thus, the control method needs to unpack the TCP/IP data to extract the event information.

In another embodiment, the event information is converted into a USB data. So that, the control method needs to recover the TCP/IP data to extract the event information.

Since the present invention uses the event information, which is generated by capturing the event of the host apparatus, the user can use habitual means to control the hand-held computing device.

### BRIEF DESCRIPTION OF THE DRAWINGS

The above objects and advantages of the present invention will become more readily apparent to those ordinarily skilled in the art after reviewing the following detailed description and accompanying drawings, in which:

FIG. 1 is a block diagram of a control system according to a first embodiment of the present invention.

FIG. 2 is a schematic diagram of a layer structure of the control system shown in the FIG. 1 according to one embodiment of the present invention.

FIG. 3 is a schematic diagram of a layer structure of the control system shown in the FIG. 1 according to another embodiment of the present invention.

FIG. 4 is a block diagram of a control system according to a second embodiment of the present invention.

FIG. 5 is a schematic diagram of a layer structure of the control system shown in the FIG. 4 according to one embodiment of the present invention.

FIG. 6 is a schematic diagram of a layer structure of the control system shown in the FIG. 4 according to another embodiment of the present invention.

FIG. 7 is a schematic diagram of a layer structure of the control system shown in the FIG. 4 according to still another embodiment of the present invention.

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

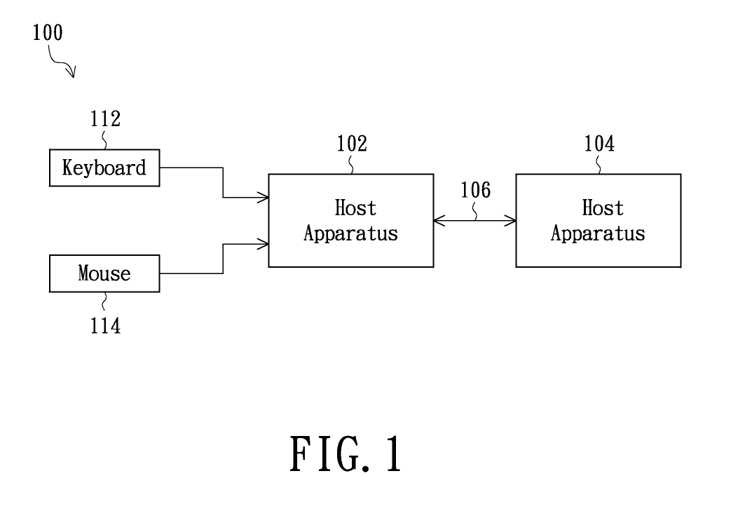

FIG. 1 is a block diagram of a control system according to a first embodiment of the present invention. Referring to FIG. 1, the control system 100 of the embodiment comprises host apparatuses 102 and 104. In this embodiment, the host apparatuses 102 and 104 are coupled through a USB transmission cable 106. Wherein, the host apparatus 102 is probably a desktop computer or a notebook computer. Therefore, the host apparatus 102 can be coupled to at least one input device, such like the keyboard 112 or mouse 114. In other embodiments, the keyboard 112 can build-in the host apparatus 102. In addition, a touch-control pad displacing the mouse 114 could build-in the host apparatus 102.

Furthermore, the host apparatus 104 is a hand-held device, such as the tablet computer or a smart phone. In this embodiment, both the host apparatuses 102 and 104 have an application program respectively.

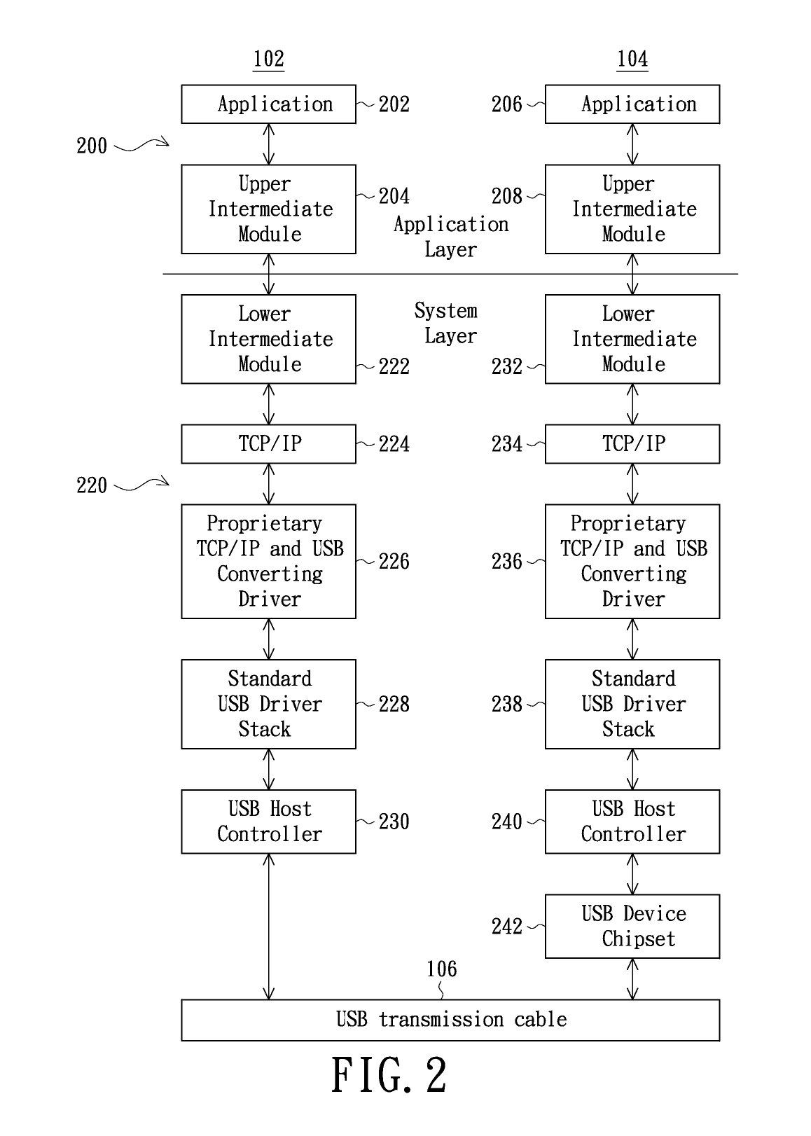

FIG. 2 is a schematic diagram of a layer structure of the control system 100 according to one embodiment of the present invention. Referring to FIG. 2, both the host apparatuses 102 and 104 have an application layer 200 and a system layer 220. In the application layer 200, the host apparatus 102 has the application program 202 and an upper intermediate module 204. In addition, the host apparatus 104 also has an application program 206 and an upper intermediate module 208 in the application layer 200.

Additionally, in the system layer 220, the host apparatus 102 has a lower intermediate module 222, a TCP/IP control unit 224, a proprietary TCP/IP and converting driver 226, a standard USB driver stack unit 228, and a USB host controller 230. Similarly, the host apparatus 104 also has a lower intermediate module 232, a TCP/IP control unit 234, a proprietary TCP/IP and converting driver 236, a standard USB driver stack unit 238, and a USB host controller 240 in the system layer 220. Furthermore, a USB device chipset 242 is configured in the system layer 220 of the host apparatus 104.

Referring to the FIGS. 1 and 2, when the host apparatus 104 links to the host apparatus 102 via the USB cable 106 and the application programs 202 and 206 is started, a plurality of steps is executed as following:

1. The USB device chipset 242 declares the host apparatus 104 as a USB device. Therefore, the application program 202 recognizes the host apparatus 104 as the USB device. In addition, the application program 202 would give the user a prompt that the input device is used to control the host apparatus 104.

2. Meanwhile, the upper intermediate module 204 and the lower intermediate module 222 would build a communication link between the host apparatuses 102 and 104. Then, the upper intermediate module 204 and the lower intermediate module 222 handshakes with the host apparatus 104.

3. When an event of the input device is triggered, such like at least one keys of the keyboard 112 being pressed or at least one key or a roll wheel of the mouse 114 being operated, the application program 202 would capture the event of the input device for generating an event information.

4. The TCP/IP control unit 224 would pack the event information into a TCP/IP data.

5. The TCP/IP data is sent to the standard USB driver stack unit 228 via the proprietary TCP/IP and USB converting driver 226. Therefore, the standard USB driver stack unit 228 converts the TCP/IP data into a USB data.

6. The USB data is sent to the USB host controller 230 by the standard USB driver stack unit 228. Therefore, the USB host controller 230 would transmit the USB data to the host apparatus 104 through the USB cable 106.

7. When the host apparatus 104 receives the USB data, the USB host controller 240 would obtain the USB data and send it to the standard USB driver stack unit 238.

8. Meanwhile, the standard USB driver stack driver 236 would convert the USB data into the TCP/IP data, and send the TCP/IP data to the TCP/IP control unit 234 via the proprietary TCP/IP and USB converting driver 236.

9. The TCP/IP control unit 234 would unpack the TCP/IP data to extract the event information.

10. The event information is sent to the application program 206 pass through the lower intermediate module 232 and the upper intermediate module 208. Therefore, the application program 206 would control the host apparatus 104 according to the event information.

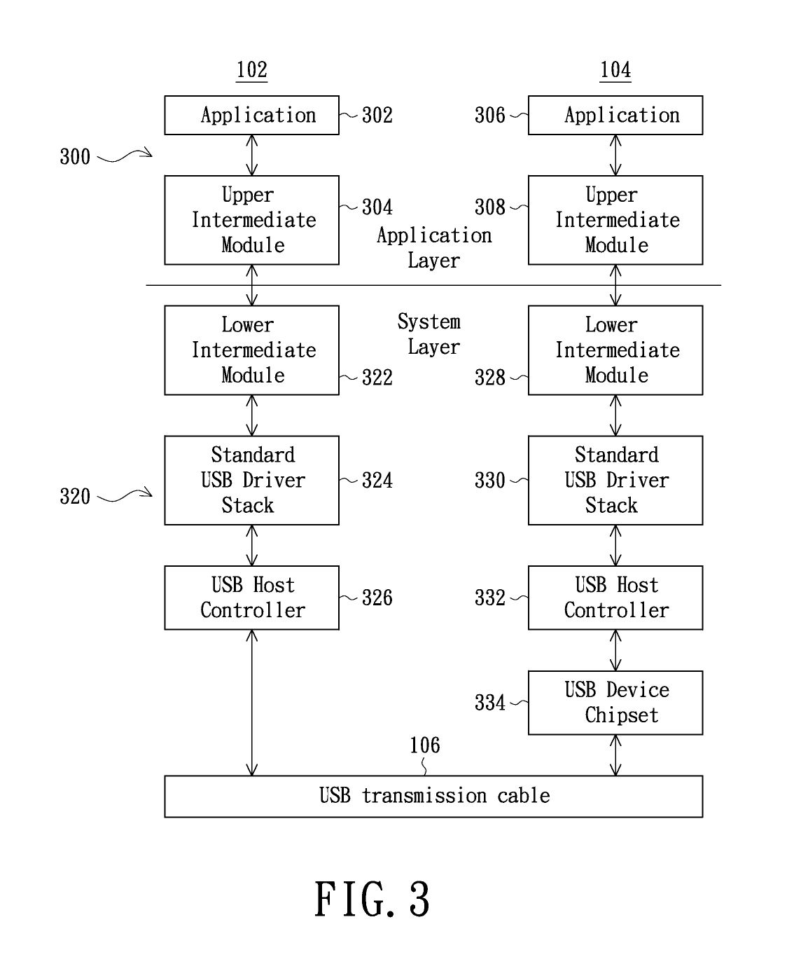

FIG. 3 a schematic diagram of a layer structure of the control system 100 according to another embodiment of the present invention. Referring to FIG. 3, in this embodiment, the host apparatus 102 and 104 also has an application layer 300 and a system layer 320. In the application layer 300, the host apparatus 102 has the application program 302, and an upper intermediate module 304. Similarly, the host apparatus 104 also has an application program 306 and an upper intermediate module 308 in the application layer 300.

Additionally, in the system layer 320, the host apparatus 102 has a lower intermediate module 322, a standard USB driver stack unit 324, and a USB host controller 326. Similarly, the host apparatus 104 also has a lower intermediate module 328, a standard USB driver stack unit 330, a USB host controller 332, and a USB device chipset 334 in the system layer 320.

When the host apparatus 104 links to the host apparatus 102 via the USB cable 106 and the application programs 302 and 306 is started, a plurality of steps is executed as following:

1. The USB device chipset 334 declares the host apparatus 104 as a USB device. Therefore, the application program 302 recognizes the host apparatus 104 as the USB device. In addition, the application program 302 would give the user a prompt that the input device is used to control the host apparatus 104.

2. Meanwhile, the upper intermediate module 304 and the lower intermediate module 322 would build a communication link between the host apparatuses 102 and 104. Then, the upper intermediate module 304 and the lower intermediate module 322 handshakes with the host apparatus 104.

3. When an event of the input device is triggered as above maintained, the application program 302 would capture the event of the input device for generating an event information.

4. The event information is sent to the standard USB driver stack unit 324 for converting the event information into a USB data.

5. Then, the USB data is sent to the USB host controller 326. Therefore, the USB host controller 326 would transmit the USB data to the host apparatus 104 through the USB cable 106.

6. When the host apparatus 104 receives the USB data, the USB host controller 332 would obtain the USB data and send it to the standard USB driver stack unit 330.

7. Meanwhile, the standard USB driver stack driver 330 would convert the USB data into the event information, and send it to the application program 306 pass through the lower intermediate module 328 and the upper intermediate module 308. Therefore, the application program 306 would control the host apparatus 104 according to the event information.

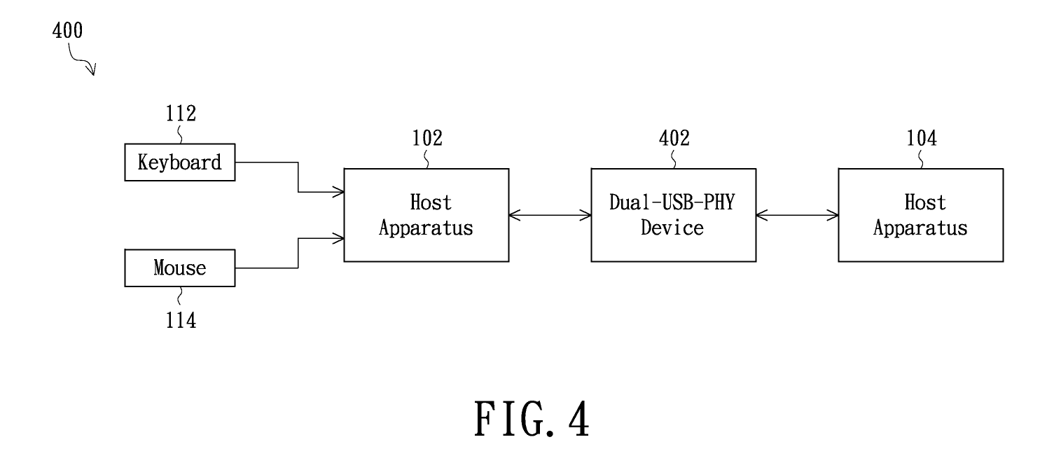

FIG. 4 is a block diagram of a control system according to a second embodiment of the present invention. Referring to FIG. 4, in this embodiment, a control system 400 is provided. In the control system 400, the host apparatus 102 is linked with the host apparatus 104 through a dual-USB-PHY device 402.

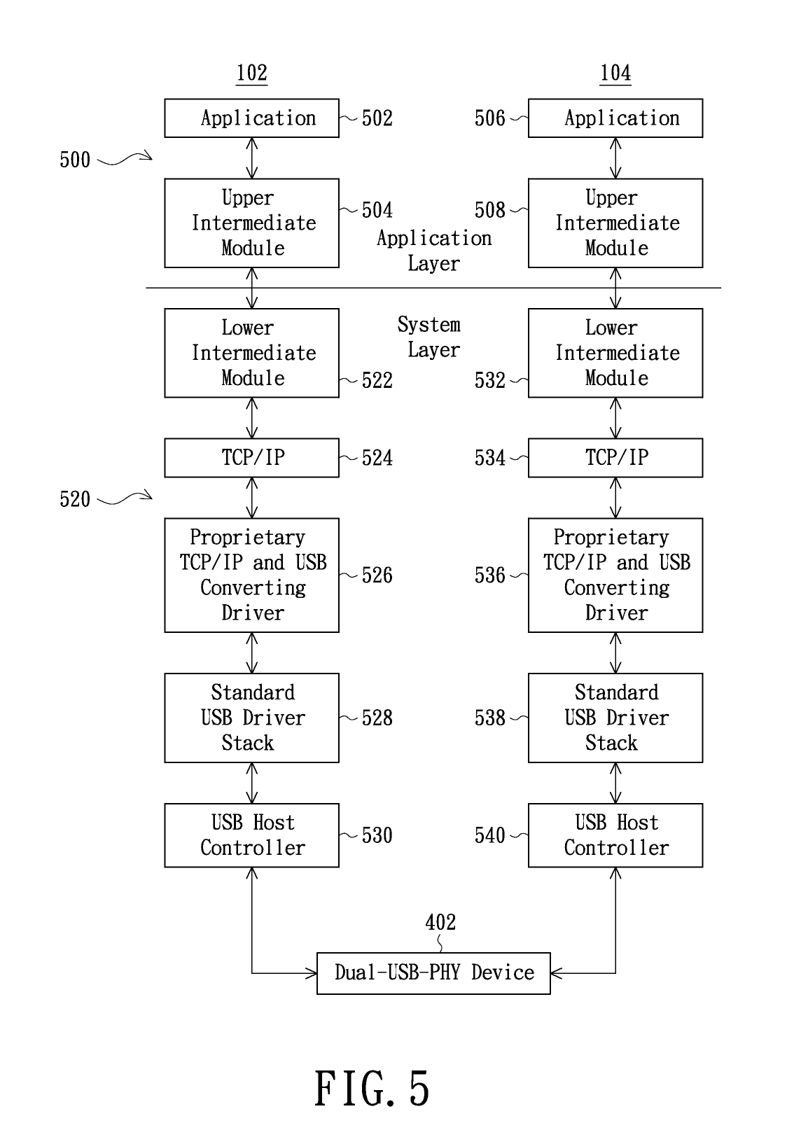

FIG. 5 is a schematic diagram of a layer structure of the control system 400 according to one embodiment of the present invention. Referring to FIG. 5, both the host apparatuses 102 and 104 have an application layer 500 and a system layer 520. In the application layer 500, the host apparatus 102 has the application program 502 and an upper intermediate module 504. The same, the host apparatus 104 has an application program 506 and an upper intermediate module 508 in the application layer 500.

Additionally, in the system layer 520, the host apparatus 102 has a lower intermediate module 522, a TCP/IP control unit 524, a proprietary TCP/IP and converting driver 526, a standard USB driver stack unit 528, and a USB host controller 530. Similarly, the host apparatus 104 also has a lower intermediate module 532, a TCP/IP control unit 534, a proprietary TCP/IP and converting driver 536, a standard USB driver stack unit 538, and a USB host controller 540.

When the host apparatus 104 links to the host apparatus 102 via the dual-USB-PHY device 402 and the application programs 502 and 506 is started, a plurality of steps is executed as following:

1. The dual-USB-PHY device 402 instead of the USB device chipset in the FIGS. 2 and 3 declares the host apparatus 104 as a USB device. Therefore, the application program 502 recognizes the host apparatus 104 as the USB device. In addition, the application program 402 would give the user a prompt that the input device is used to control the host apparatus 104.

2. Meanwhile, the upper intermediate module 504 and the lower intermediate module 522 would build a communication link between the host apparatuses 102 and 104. Then, the upper intermediate module 504 and the lower intermediate module 522 handshakes with the host apparatus 104.

3. When an event of the input device is triggered as above maintained, the application program 502 would capture the event of the input device for generating an event information.

4. The TCP/IP control unit 524 would pack the event information into a TCP/IP data.

5. The TCP/IP data is sent to the standard USB driver stack unit 528 via the proprietary TCP/IP and USB converting driver 526. Therefore, the standard USB driver stack unit 528 converts the TCP/IP data into a USB data.

6. The USB data is sent to the USB host controller 526 by the standard USB driver stack unit 528. Therefore, the USB host controller 530 would transmit the USB data to the host apparatus 104 through the dual-USB-PHY device 402.

7. When the host apparatus 104 receives the USB data, the USB host controller 540 would obtain the USB data and send it to the standard USB driver stack unit 538.

8. Meanwhile, the standard USB driver stack driver 536 would convert the USB data into the TCP/IP data, and send the TCP/IP data to the TCP/IP control unit 534 via the proprietary TCP/IP and USB converting driver 536.

9. The TCP/IP control unit 534 would unpack the TCP/IP data to extract the event information.

10. The event information is sent to the application program 506 pass through the lower intermediate module 532 and the upper intermediate module 508. Therefore, the application program 506 would control the host apparatus 104 according to the event information.

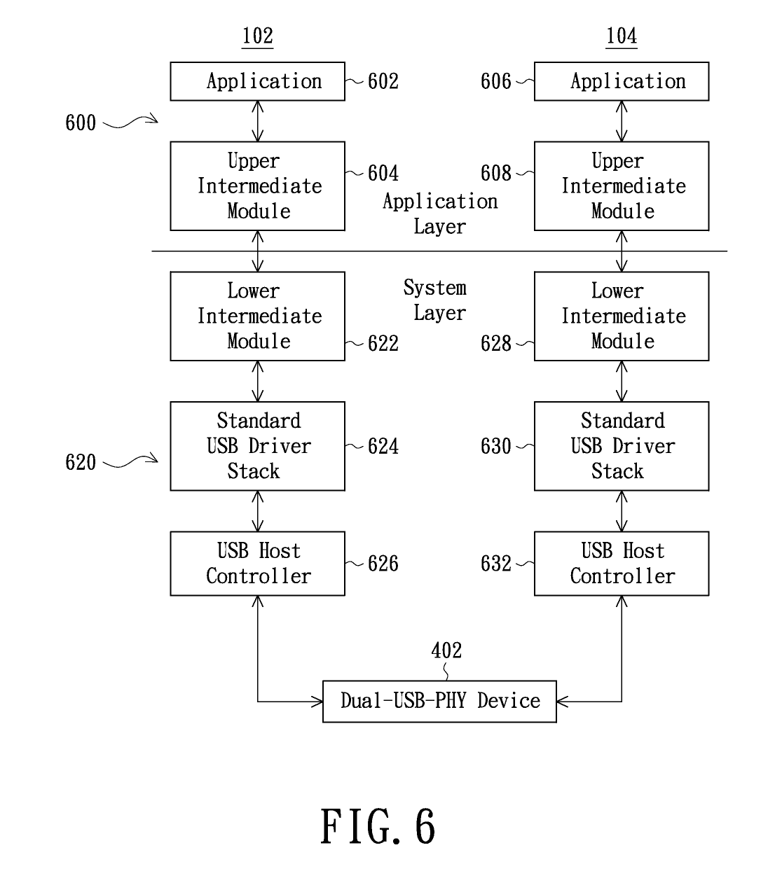

FIG. 6 is a schematic diagram of a layer structure of the control system 400 according to another embodiment of the present invention. Referring to FIG. 6, in this embodiment, the host apparatus 102 and 104 also has an application layer 600 and a system layer 620. In the application layer 600, the host apparatus 602 has the application program 602, and an upper intermediate module 604. Similarly, the host apparatus 104 also has an application program 606 and an upper intermediate module 608 in the application layer 600.

Additionally, in the system layer 620, the host apparatus 602 has a lower intermediate module 622, a standard USB driver stack unit 624, and a USB host controller 626. Similarly, the host apparatus 104 also has a lower intermediate module 628, a standard USB driver stack unit 630, and a USB host controller 632 in the system layer 620.

When the host apparatus 104 links to the host apparatus 102 via the USB cable 106 and the application programs 602 and 606 is started, a plurality of steps is executed as following:

1. The dual-USB-PHY device 402 declares the host apparatus 104 as a USB device. Therefore, the application program 602 recognizes the host apparatus 104 as the USB device. In addition, the application program 602 would give the user a prompt that the input device is used to control the host apparatus 104.

2. Meanwhile, the upper intermediate module 604 and the lower intermediate module 622 would build a communication link between the host apparatuses 102 and 104. Then, the upper intermediate module 604 and the lower intermediate module 622 handshakes with the upper intermediate module 608 and the lower intermediate module 628.

3. When an event of the input device is triggered as above maintained, the application program 602 would capture the event of the input device for generating an event information.

4. The event information is sent to the standard USB driver stack unit 624 for converting the event information into a USB data.

5. Then, the USB data is sent to the USB host controller 626. Therefore, the USB host controller 626 would transmit the USB data to the host apparatus 104 through the dual-USB-PHY 402.

6. When the host apparatus 104 receives the USB data, the USB host controller 632 would obtain the USB data and send it to the standard USB driver stack unit 630.

7. Meanwhile, the standard USB driver stack driver 630 would convert the USB data into the event information, and send it to the application program 606 pass through the lower intermediate module 628 and the upper intermediate module 608. Therefore, the application program 606 would control the host apparatus 104 according to the event information.

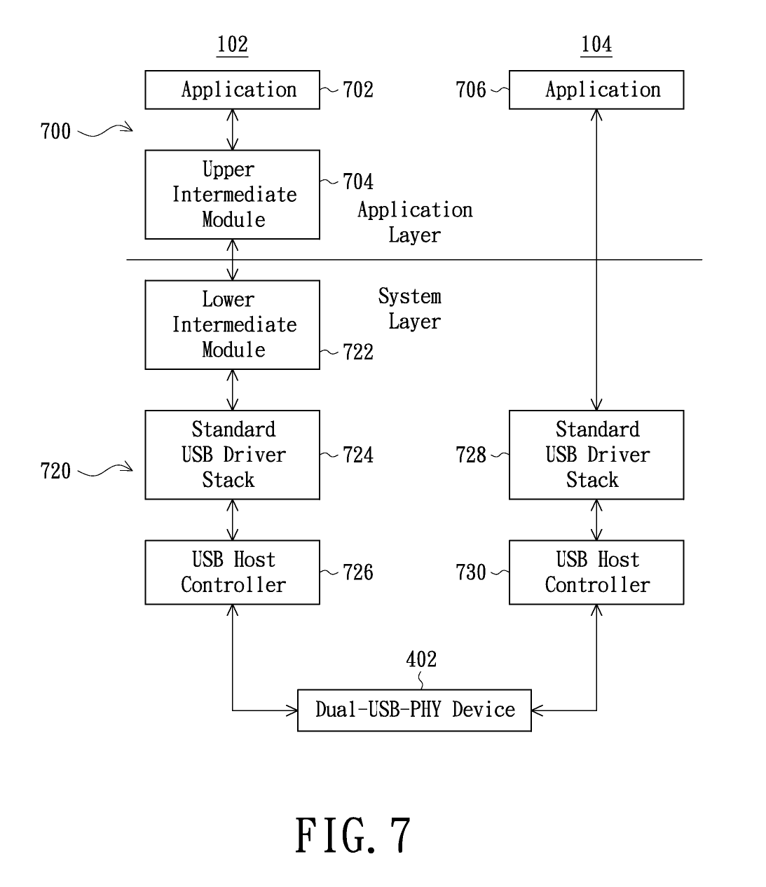

FIG. 7 is a schematic diagram of a layer structure of the control system 400 according to still another embodiment of the present invention. Referring to FIG. 7, in this embodiment, the host apparatus 102 and 104 also has an application layer 700 and a system layer 720. In the application layer 700, the host apparatus 102 has the application program 702, and an upper intermediate module 704. In particularly, the host apparatus 104 just has an application program 706 in the application layer 700.

Additionally, in the system layer 720, the host apparatus 702 has a lower intermediate module 722, a standard USB driver stack unit 724, and a USB host controller 726. In addition, the host apparatus 104 has a standard USB driver stack unit 728 and a USB host controller 730 in the system layer 720.

When the host apparatus 104 links to the host apparatus 102 via the dual-USB-PHY device 402 and the application programs 702 and 706 is started, a plurality of steps is executed as following:

1. The dual-USB-PHY device 402 declares the host apparatus 104 as a USB device. Therefore, the application program 702 recognizes the host apparatus 104 as the USB device. In addition, the application program 702 would give the user a prompt that the input device is used to control the host apparatus 104.

2. Meanwhile, the upper intermediate module 704 and the lower intermediate module 722 would build a communication link between the host apparatuses 102 and 104. Then, the upper intermediate module 604 and the lower intermediate module 722 handshakes with the host apparatus 104.

3. When an event of the input device is triggered as above maintained, the application program 702 would capture the event of the input device for generating an event information.

4. The event information is sent to the standard USB driver stack unit 724 for converting the event information into a USB data.

5. Then, the USB data is sent to the USB host controller 726. Therefore, the USB host controller 726 would transmit the USB data to the host apparatus 104 through the dual-USB-PHY 402.

6. When the host apparatus 104 receives the USB data, the USB host controller 730 would obtain the USB data and send it to the standard USB driver stack unit 728.

7. Meanwhile, the standard USB driver stack driver 728 would convert the USB data into the event information, and send it to the application program 706. Therefore, the application program 706 would control the host apparatus 104 according to the event information.

In some embodiments, when the host apparatus 102 is connected with the host apparatus 104, the application program installed into the host apparatus 102 further determines whether or not the host apparatus 104 is a permitted host apparatus. For example, the application program installed into the host apparatus 102 would determine whether or not a predetermined information is stored in the host apparatus 104. Wherein, the predetermined information is probably at least one of serial number, vendor name and a specific phone number.

If the application program installed into the host apparatus 104 determines that the predetermined information is stored in the host apparatus 104, the application program installed into the host apparatus 102 would authenticate that the host apparatus 104 is the permitted host apparatus. So that, the application program installed into the host apparatus 102 would control the host apparatus 102 transmitting the event information to the host apparatus 104, such that the host apparatus 104 is controlled according to the event information. However, if the host apparatus 104 is not authenticated as the permitted host apparatus, the application program installed into the host apparatus 102 would forbid transmitting the event information to the host apparatus 104.

In summary, the present invention can use the event information, which is generated by operating an input device coupled to a host apparatus, to control another host apparatus, such as the hand-held computing device. Therefore, the present invention allows the user use habitual control means to control the hand-held computing device.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. An operation method for a first host apparatus, comprising:
capturing an event of the first host apparatus for generating an event information; and
transmitting the event information to a second host apparatus, so as to control the second host apparatus.

2. The operation method according to claim 1, further comprising:
building a communication link to the second host apparatus; and
handshaking with the second host apparatus.

3. The operation method according to claim 1, wherein transmitting the event information to the second host apparatus comprises:
packing the event information into a TCP/IP data on the first host apparatus; and
transmitting the TCP/IP data to the second host apparatus according the TCP/IP protocol.

4. The operation method according to claim 1, wherein transmitting the event information to the second host apparatus comprises:
converting the event information into a USB data on the first host apparatus; and
transmitting the USB data to the second host apparatus on a USB transmission interface.

5. The operation method according to claim 1, wherein capturing the event of the first host apparatus comprises:
detecting whether or not at least one of a plurality of keys of a keyboard connected to the first host apparatus is pressed; and
determining the event is triggered, when at least one of keys of the keyboard is pressed.

6. The operation method according to claim 1, wherein capturing the event of the first host apparatus comprises:
detecting whether or not a mouse connected to the first host apparatus is moved or at least one of keys or the roll wheel of the mouse is operated; and
determining the event is triggered, when the mouse is moved or one of keys or the roll wheel is operated.

7. The operation method according to claim 1, further comprising:
determining whether a predetermined information is stored in the second host apparatus while connecting the first host apparatus with the second host apparatus; and
forbidding transmitting the event information to the second host apparatus when the predetermined information is not stored therein.

8. The operation method according to claim 7, wherein the predetermined information comprises serial number, vendor name or specific phone number.

9. The operation method according to claim 1, wherein when the event information is transmitted to the second host apparatus, a virtual input screen on the second host apparatus is disabled.

10. A control method for a first host apparatus, comprising:
receiving an event information from a second host apparatus, wherein the event information is generated by capturing an event of the second host apparatus; and
controlling the host apparatus according to the event information.

11. The control method according to claim 10, further comprising:
declaring the first host apparatus as a USB device, so as to receive the event information.

12. The control method according to claim 10, wherein the event information is packed into a TCP/IP data.

13. The control method according to claim 12, further comprising:
unpacking the TCP/IP data to extract the event information.

14. The control method according to claim 10, wherein the event information is converted into a USB data.

15. The control method according to claim 14, further comprising:
recovering the USB data to extract the event information.

16. The control method according to claim 10, further comprising:
authenticating whether or not the first host apparatus is a permitted host apparatus; and
using the event information to control the first host apparatus, when the first host apparatus is the permitted host apparatus.

17. The control method according to claim 10, further comprising:
disabling a virtual keyboard interface shown on a screen of the first host apparatus according to a user's operation, when the first host apparatus is the permitted host apparatus.
